(19) United States
(12) Patent Application Publication
(10) Pub. No.: US 2021/0050814 A1
(43) Pub. Date: Feb. 18, 2021

(54) APPARATUS FOR CLEANING SOLAR PANEL

(71) Applicant: TOBE. CO. LTD., Gwangju (KR)

(72) Inventor: Sangchae LIM, Gwangju (KR)

(21) Appl. No.: 16/683,286

(22) Filed: Nov. 14, 2019

(30) Foreign Application Priority Data
Aug. 16, 2019 (KR) 10-2019-0100437

(51) Int. Cl. H02S 40/10

(52) U.S. Cl. CPC H02S 40/10

(57) ABSTRACT

According to an embodiment, a solar panel cleaning apparatus moving on a solar panel to remove foreign bodies from the solar panel comprises a brush unit including a first shaft, a first timing pulley formed at each of two opposite ends of the first shaft, and a brush provided around the first shaft, an apparatus moving unit including a second shaft, a second timing pulley formed at each of two opposite ends of the second shaft, and a roller provided in a preset position of the second shaft, the roller contacting the solar panel, a connector connecting the first timing pulley with the second timing pulley, and a motor providing a rotational force to the first shaft of the brush unit, wherein the brush unit may approach or move away from the solar panel.

### CROSS-REFERENCE TO RELATED APPLICATION(S)

This application is based on and claims priority under 35 U.S.C. 119 to Korean Patent Application No. 10-2019-0100437, filed on Aug. 16, 2019, in the Korean Intellectual Property Office, the disclosure of which is herein incorporated by reference in its entirety.

### TECHNICAL FIELD

Various embodiments of the disclosure relate to apparatus for cleaning solar panels.

### DESCRIPTION OF RELATED ART

The description of the Discussion of Related Art section merely provides information that may be relevant to embodiments of the disclosure but should not be appreciated as necessarily constituting the prior art.

With rapid advances in photovoltaic technology, solar energy is replacing fossil fuels. Solar power generation is the conversion of energy from sunlight into electricity by focusing sunlight onto solar panels. Generally, solar panels are installed in outdoor sites with ample sunlight. Where solar panels are installed on buildings, impurities in the rain and air may build up on the surface of the panels, blocking light and resultantly lowering light concentration efficiency.

To maintain light concentration efficiency, solar panels need to be cleaned up periodically. Manual cleanup consumes too high labor costs, increasing maintenance fees. Recent issues with yellow dust, fine, and micro dust in the air lead to demand for more frequent cleanup on solar panels.

An approach to address such issues is use of robots for cleaning solar panels. The robots have brushes and get rid of foreign bodies while moving on the panels. The brushes are consumables which get worn out if used for a predetermined time and thus fail to do its job properly. As such, conventional solar panel robots require replacement of cleanup brushes, resulting in excessive cost consumption.

### SUMMARY

According to an embodiment, there may be provided a solar panel cleanup apparatus that may enhance the lifespan of its consumables by adjusting the position of the consumables.

According to an embodiment, a solar panel cleaning apparatus moving on a solar panel to remove foreign bodies from the solar panel comprises a brush unit including a first shaft, a first timing pulley formed at each of two opposite ends of the first shaft, and a brush provided around the first shaft, an apparatus moving unit including a second shaft, a second timing pulley formed at each of two opposite ends of the second shaft, and a roller provided in a preset position of the second shaft, the roller contacting the solar panel, a connector connecting the first timing pulley with the second timing pulley, and a motor providing a rotational force to the first shaft of the brush unit, wherein the brush unit may approach or move away from the solar panel.

The brush unit may further include a shaft lift unit to move the first shaft close to or away from the solar panel.

The shaft lift unit may include a thread. When a coupling member is coupled to the shaft lift unit through the thread, the brush unit may approach or move away from the solar panel.

The apparatus moving unit may receive the rotational force via the connector, and the apparatus moving unit may receive mechanical power for moving on the solar panel via the roller.

The apparatus moving unit may include a plurality of rollers. Each of the plurality of rollers may contact a first end of the solar panel or a second end of the solar panel. The second end of the solar panel is positioned opposite to the first end of the solar panel.

The second timing pulley may be larger in diameter than the first timing pulley.

As set forth above, the embodiments of the disclosure may adjust the position of consumables in the apparatus, enhancing the lifespan of the consumables and hence saving consumable replacement costs.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a perspective view illustrating a solar panel cleaning apparatus according to an embodiment;

FIG. 2 is an exploded perspective view illustrating a solar panel cleaning apparatus according to an embodiment;

FIG. 3 is a view illustrating an example in which a front cover of a case is opened according to an embodiment;

FIG. 4 is a view illustrating an example in which a rear cover of a case is opened according to an embodiment;

FIG. 5 is a view illustrating an upper module of a solar panel cleaning module according to an embodiment;

FIGS. 6 and 7 are views illustrating a motor base plate according to an embodiment;

FIG. 8 is a view illustrating a brush unit, a moving unit, and a lower module of a solar panel cleaning module according to an embodiment;

FIGS. 9A and 9B are views illustrating operations of a shaft lift according to an embodiment;

FIG. 10 is a view illustrating a connector tension controller according to an embodiment;

FIG. 11 is a view illustrating an example in which an assistant brush is coupled according to an embodiment;

FIG. 12 is a view illustrating a charging terminal according to an embodiment;

FIG. 13 is a view illustrating a solar panel state diagnosis system according to an embodiment;

FIG. 14 is a view illustrating a configuration of a solar panel cleaning robot according to an embodiment;

FIG. 15 is a view illustrating a configuration of a diagnosis server according to an embodiment;

FIG. 16 is a view illustrating an example in which a solar panel cleaning robot is mounted on a solar panel according to an embodiment;

FIG. 17 is a view illustrating a configuration of an electric field and magnetic field sensor of a solar panel cleaning robot according to an embodiment; and

FIG. 18 is a flowchart illustrating a method of diagnosing abnormalities in solar panels by a solar panel state diagnosis system according to an embodiment.

### DETAILED DESCRIPTION OF EXEMPLARY EMBODIMENTS

Various changes may be made to the present invention, and the present invention may come with a diversity of embodiments. Some embodiments of the present invention are shown and described in connection with the drawings. However, it should be appreciated that the present disclosure is not limited to the embodiments, and all changes and/or equivalents or replacements thereto also belong to the scope of the present disclosure. Similar reference denotations are used to refer to similar elements throughout the drawings.

The terms “first” and “second” may be used to describe various components, but the components should not be limited by the terms. The terms are used to distinguish one component from another. For example, a first component may be denoted a second component, and vice versa without departing from the scope of the present disclosure. The term “and/or” may denote a combination(s) of a plurality of related items as listed or any of the items.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is “directly connected to” or “directly coupled to” another component, no other intervening components may intervene therebetween.

The terms as used herein are provided merely to describe some embodiments thereof, but not to limit the present disclosure. As used herein, the singular forms “a,” “an,” and “the” are intended to include the plural forms as well, unless the context clearly indicates otherwise. As used herein, the term “comprise,” “include,” or “have” should be appreciated not to preclude the presence or addability of features, numbers, steps, operations, components, parts, or combinations thereof as set forth herein.

Unless otherwise defined, all terms including technical and scientific terms used herein have the same meaning as commonly understood by one of ordinary skill in the art to which the embodiments of the present disclosure belong.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The components, processes, steps, or methods according to embodiments of the disclosure may be shared as long as they do not technically conflict with each other.

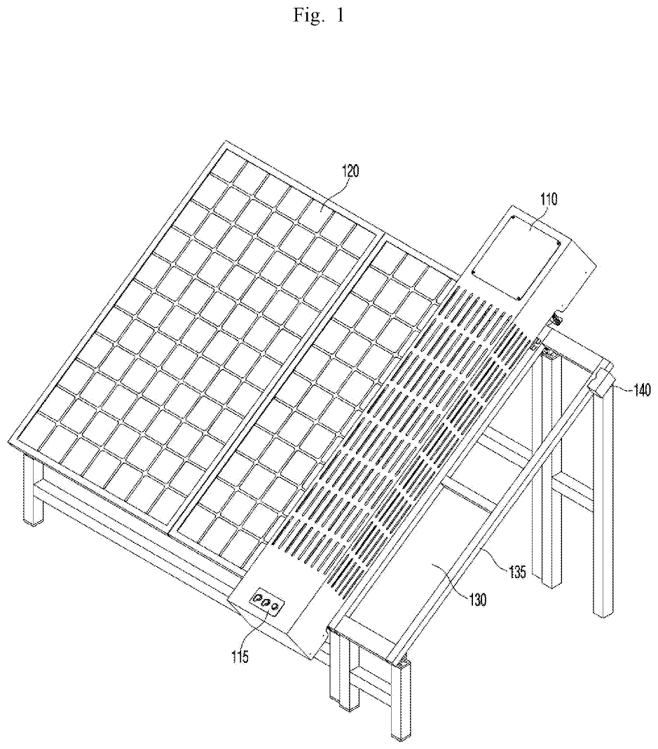

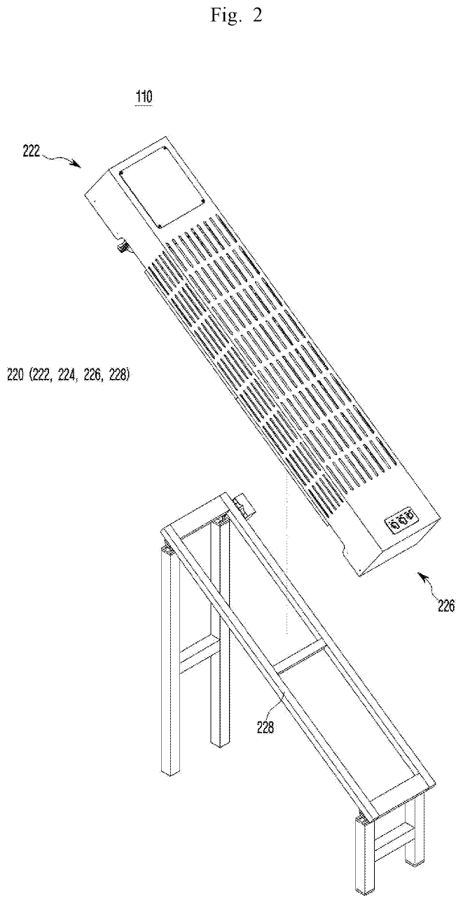

FIG. 1 is a perspective view illustrating a solar panel cleaning apparatus according to an embodiment. FIG. 2 is an exploded perspective view illustrating a solar panel cleaning apparatus according to an embodiment.

Referring to FIGS. 1 and 2, according to an embodiment, a solar panel cleaning apparatus 110 includes a case 210 and a solar panel cleaning module 220.

A solar panel 120 is a component that receives sunlight and converts the sunlight into electric energy and stores the electric energy. The solar panel 120 includes a plurality of unit panels each of which is shaped as a plate and includes a plurality of solar cells. The solar panel 120 may have a plurality of unit panels arranged on one surface thereof, and its size or shape may be varied depending on the place where it is installed or the shape of the solar cells. The surface of the solar panel 120, on which the unit panels are arranged, may be divided into a first portion where the unit panels are arranged and a second portion where no unit panel is disposed. The solar panel cleaning module 220 may move on the second portion while cleaning the first portion. Typically, the solar panel 120 may be installed to be inclined and face in a specific direction (e.g., south-facing) to receive more incident sunlight. Since the solar panel 120 is installed and fastened in a specific position and is thus exposed to the external environment, various foreign bodies or matters may be attached to the surface of the solar panel 120, thus deteriorating the power generation efficiency of the solar panel 120. The solar panel cleaning apparatus 110 removes foreign bodies or matters from the surface of the solar panel 120.

A station 130 is provided on one side of the solar panel 120 to station the solar panel cleaning apparatus 110. If the solar panel cleaning apparatus 110 stays on the solar panel 120 even after cleaning is complete, the power generation efficiency of the solar panel 120 may be lowered. The station 130 includes frames 135 which are provided on one side of the solar panel 120 to station the solar panel cleaning apparatus 110 thereon. The station 130 also includes a charging terminal 140 for charging the battery of the solar panel cleaning apparatus 110. If the solar panel cleaning apparatus 110 operates and runs out of the power of the battery therein, the battery of the solar panel cleaning apparatus 110 may be recharged by the charging terminal 140 of the station 130 without the need for removal of the battery. Thus, the solar panel cleaning apparatus 110 may be charged while staying on the station 130.

The solar panel cleaning apparatus 110 removes foreign bodies or matters (e.g., dust) from the surface of the solar panel 120 while moving on the solar panel 120. For example, the solar panel cleaning module 220 of the solar panel cleaning apparatus 110 moves on the solar panel 120 while removing foreign bodies from the surface of the solar panel 120. The case 210 of the solar panel cleaning apparatus 110 covers the solar panel cleaning module 220 to prevent the solar panel cleaning module 220 from escaping off and protect the solar panel cleaning module 220 from external forces.

The case 210 may be formed of a material with a preset strength. The case 210 may be coupled to the solar panel cleaning module 220 through the outermost edge of the solar panel cleaning module 220, and the case 210 covers the solar panel cleaning module 220, with the case 210 spaced apart from each component of the solar panel cleaning module 220. Thus, the solar panel cleaning module 220 may be prevented from escaping off naturally by gravity or mistakenly by others and, if an external force is exerted, the components inside the solar panel cleaning module 220 may be prevented from damage. The case 210 includes a front cover and a rear cover.

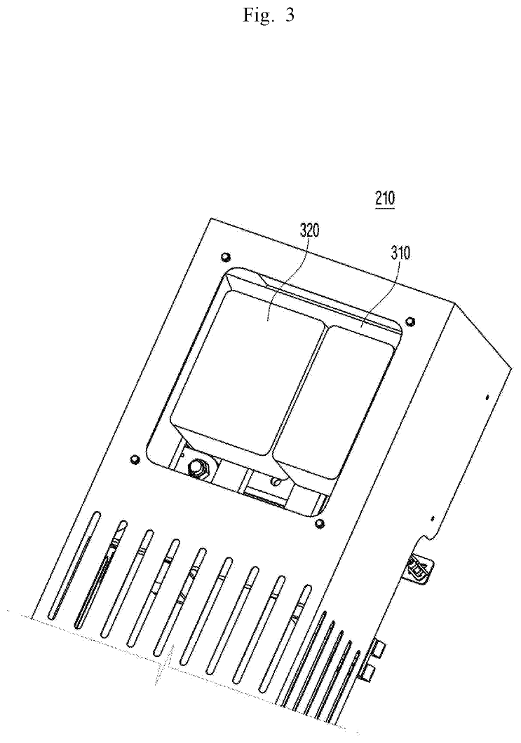

FIG. 3 is a view illustrating an example in which a front cover of a case is opened according to an embodiment.

The case 210 includes a front cover 310, which is openable, in one end thereof. The front cover 310 is formed in an end of the case 210, where a controller and a battery 320 of the solar panel cleaning module 220 are positioned. The front cover 310 may be opened and closed. When the front cover 310 is opened, the controller and the battery 320 are exposed. Sometimes, a need may arise for battery replacement or check or repair of the controller in the solar panel cleaning module 220. In such cases, if the case 210 didn't have the front cover 310, the overall case 210 would be required to be removed from the solar panel cleaning module 220. This is quite bothering and inconvenient. The manager or user of the solar panel cleaning apparatus 110 may easily replace the battery or repair the controller by simply opening the front cover 310. The “front” as in the front cover 310 means a surface of the case 210 through which most of sunlight is received.

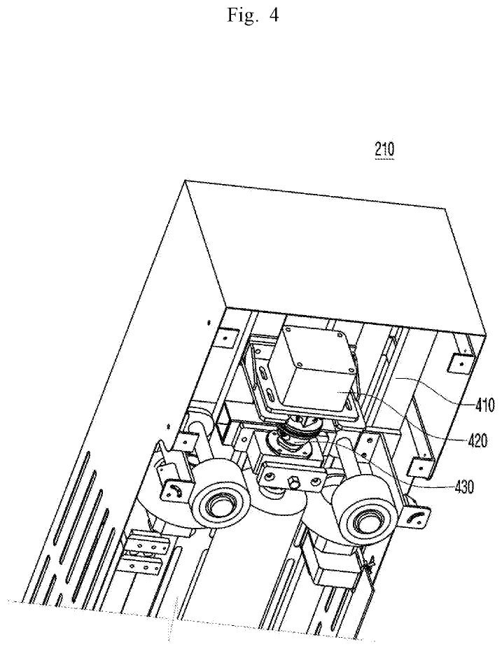

FIG. 4 is a view illustrating an example in which a rear cover of a case is opened according to an embodiment.

The case 210 includes a rear cover 410 which is opposite to the front cover 310. The rear cover 410 is formed in one end of the case 210, where a motor 420 of the solar panel cleaning module 220 is positioned. Like the front cover 310, the rear cover 410 may be opened and closed and facilitate repair or replacement of any component (e.g., the motor 420) positioned in the case 210. The motor 420 included in the solar panel cleaning module 220 provides mechanical power to allow the solar panel cleaning module 220 to clean the solar panel 120 and to move on the solar panel 120. As such, the motor 420 may be a component that has a direct influence on the cleanup of the solar panel 120. The motor 420 requires periodic maintenance and, if broken, needs to be repaired or replaced immediately. Without the rear cover 410, it might be required for the whole case 210 to be removed from the solar panel cleaning module 220 for maintenance or repair or replacement work. This would be inconvenient. The rear cover 410 of the case 210 may facilitate repair or replacement of the motor 420. As described below, the motor 420 may be connected to a brush shaft and a coupling member 430 and may easily be removed from the shaft by detaching the coupling member 430. In other words, the manager or user may remove the motor 420 alone from the solar panel cleaning module 220 by simply opening the rear cover 410 and detaching the coupling member 430.

Referring back to FIGS. 1 and 2, the solar panel cleaning module 220 includes an upper module 222, a brush unit 224, a lower module 226, and an assistant brush 228.

The upper module 222 and the lower module 226 enable the solar panel cleaning module 220 to move on the solar panel while preventing the solar panel cleaning apparatus 110 from escaping off the solar panel 120. The upper module 222 and the lower module 226 are positioned in an upper portion and lower portion, respectively, of the solar panel cleaning module 220 and are connected to both ends of the brush to move and operate the brush on the solar panel 120. The term “upper portion” means a relatively high position or portion from the ground where the solar panel 120 is installed, and the term “lower portion” means a relatively low position or portion from the ground where the solar panel 120 is installed.

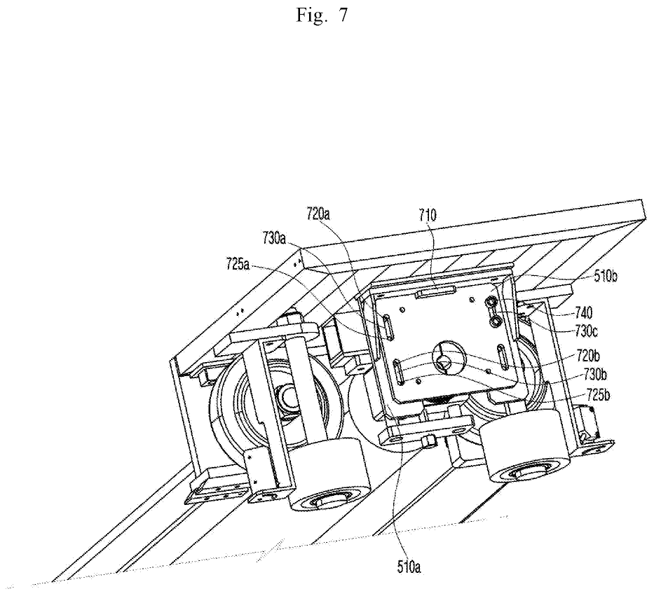

The brush unit 224 and the assistant brush 228 are moved on the solar panel 120 by the upper module 222 and the lower module 226, removing foreign bodies from the surface of the solar panel 120. The assistant brush 228 is disposed ahead of the brush unit 224 in one direction along which the solar panel cleaning module 220 moves on the solar panel 120, removing relatively large foreign bodies before the brush unit 224 removes foreign bodies. Relatively large foreign bodies may accelerate wear and tear to the brush unit 224 and may occasionally damage the brush unit 224. The assistant brush 228 removes such relatively large foreign bodies. The brush unit 224 receives mechanical power from the upper module 222 or the lower module 226, rotating while moving on the solar panel 120. By rotation, the brush unit 224 may completely remove foreign bodies from the surface of the solar panel 120. The brush unit 224 is described below in greater detail with reference to FIG. 8.

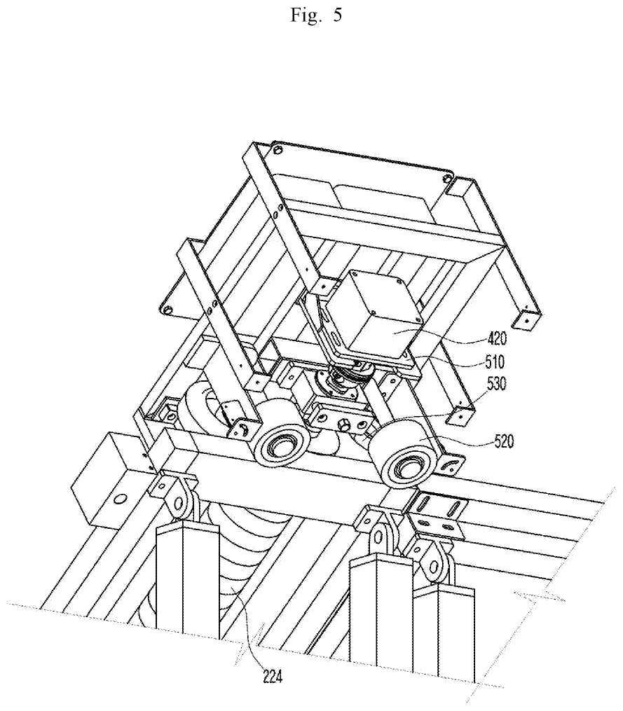

FIG. 5 is a view illustrating an upper module of a solar panel cleaning module according to an embodiment.

Referring to FIG. 5, according to an embodiment, the upper module 222 includes a motor 420, a motor base plate 510, a first roller 520, a second roller 530, a controller (not shown), and a battery (not shown).

The motor 420 provides mechanical power to a shaft (which is described below in connection with FIG. 8) in the brush unit 224, allowing the brush unit 224 to rotate. As described above in connection with FIG. 4, the motor 420 is connected with the shaft of the brush unit 224 by the coupling member 430. The motor 420 supplies a rotational force to the shaft to allow the shaft to rotate and, as the shaft rotates, the brush in the brush unit 224 may rotate.

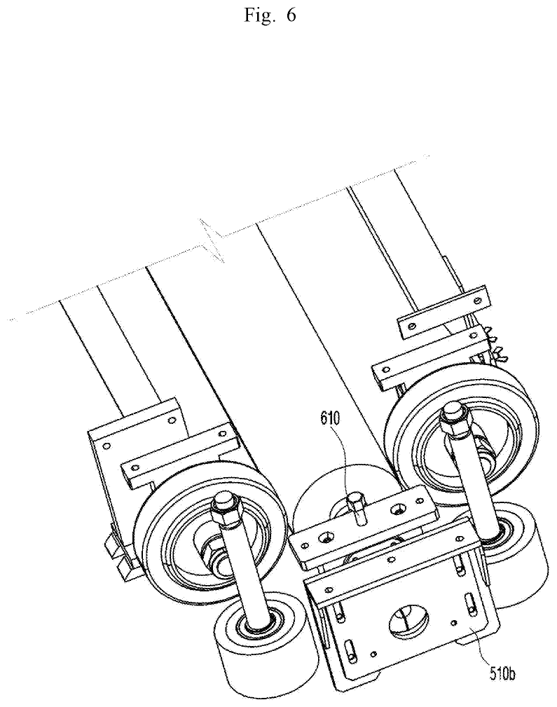

The motor 420 may be attached to the motor base plate 510, and the motor base plate 510 may move up or down the attached motor 420 along with the shaft in the brush unit 224. The motor 420 is attached and fastened to the motor base plate 510. The motor base plate 510 may be moved up or down as much as the shaft is moved or down by the manager or under the control of the controller (not shown). The motor base plate 510 is described below with reference to FIGS. 6 and 7.

FIGS. 6 and 7 are views illustrating a motor base plate according to an embodiment.

Referring to FIGS. 6 and 7, the motor base plate 510 includes a first surface 510a and a second surface 510b. The first surface 510a includes fastening units 720a to 720d and 725a to 725d. The second surface 510b is positioned on the first surface 510a, and the second surface 510b includes a coupling member introduction hole 610, a coupling unit 710, and fastening member introduction holes 730a to 730d. The motor 420 is attached to the second surface 510b on the first surface 510a.

A coupling member (not shown) for adjusting the ascent and descent of the motor is introduced through the coupling member introduction hole 610. The coupling member introduction hole 610 may have a diameter identical to, or larger than, the diameter of the coupling member to allow the coupling member to be introduced through the coupling member introduction hole 610 and contact the coupling unit 710. The coupling member (not shown) may be implemented as any member that may transfer a whole external force exerted to push out the coupling unit 710. For example, the coupling member may be implemented as a screw. The coupling member introduction hole 610 may have an internal thread, and the coupling member (not shown) may approach the coupling unit 710 along the internal thread of the coupling member introduction hole 610 and push out the coupling unit of the second surface 510b.

The coupling unit 710 is formed under the coupling member introduction hole 610 in the vertical direction and receive an external force from the coupling member (not shown). If the external force is transferred to the coupling unit 710 by the coupling member (not shown), the second surface 510b descends.

The fastening units 720a to 720d and 725a to 725d are formed on the first surface 510a to allow a fastening member 740 to couple to all or some of the fastening units 720a to 720d and 725a to 725d via the fastening member introduction holes 730a to 730d to thereby fasten the second surface 510b. The fastening units 720a to 720d and 725a to 725d may be formed in a plurality of positions (e.g., edges or corners of the first surface 510a) on the first surface 320a, and two or more fastening units may be formed in each position. As set forth above, the second surface 510b may be moved down by the coupling member (not shown). If only fastening unit is formed in each position, it may be hidden by the descending second surface 510b, and the fastening member 740 may fail to couple to the fastening unit in each position. Thus, two or more of the fastening units 720a to 720d and 725a to 725d are formed up and down in each position.

The fastening member introduction holes 730a to 730d are formed in the second surface 510b to allow the fastening member 740 to be introduced into the fastening units 720a to 720d and 725a to 725d formed in the first surface 510a. Unless the coupling unit 710 descends, the second surface 510b is initially positioned to expose all of the fastening units 720a to 720d and 725a to 725d through the fastening member introduction holes 730a to 730d. As the second surface 510b descends, the fastening member introduction holes 730a to 730d also descend, so that the fastening units 720a to 720d positioned up are hidden by the second surface 510b, and the fastening units 725a to 725d positioned down are exposed through the fastening member introduction holes 730a to 730d. As such, the fastening units exposed through the fastening member introduction holes 730a to 730d are coupled with the fastening member 740, fastening the second surface 510b.

By the operation of each component of the motor base plate 510, the motor 420 attached to the second surface 510b may descend together with the motor base plate 510. The degree to which the motor 420 and the motor base plate 510 descend may be the same as the degree to which the shaft of the brush unit 224 descends.

Referring back to FIG. 5, the first roller 520 enables the solar panel cleaning module 220 to move without escaping off the solar panel 120. The first roller 520 projects from the upper module 222 in a direction along which sunlight is incident onto the solar panel 120 and contacts a top surface of the solar panel 120, which is perpendicular to the surface of the solar panel 120 where solar cells or unit panels are formed. As the first roller 520 contacts the top surface of the solar panel 120, the first roller 520 may prevent the solar panel cleaning module 220 from falling and escaping off the solar panel 120 which is inclined while allowing the solar panel cleaning module 220 to move on the solar panel 120.

The second roller 530 allows the solar panel cleaning module 220 to move on the solar panel 120. The second roller 530 contacts the portion, where no unit panel is disposed, of the surface where the solar cells or unit panels are formed, and the second roller 530, along with the first roller 520, allows the solar panel cleaning module 220 to move on the solar panel 120.

The controller (not shown) controls the motor 420 to provide, or refrain from providing, mechanical power.

The controller (not shown) may control the ascent or descent of the motor base plate 510 or a shaft lift unit or connector tension controller which is described below. The solar panel cleaning apparatus 110 enables the motor 420 to provide mechanical power to a coupling member or fastening member for controlling the ascent or descent of the shaft lift unit or connector tension controller or the motor base plate 510, or the solar panel cleaning apparatus 110 may further include an additional motor to provide mechanical power. The controller (not shown) may control the mechanical power provided to the coupling member or fastening member for controlling the ascent or descent of the shaft lift unit or connector tension controller or the motor base plate 510, thereby controlling the ascent or descent of the shaft lift unit or connector tension controller or the motor base plate 510. Since the wear and tear on the brush may be proportional to the time during which the brush operates, the controller (not shown) may grasp whether the time during which the brush unit 224 operates exceeds a preset time and, if exceeding the preset time, perform control to allow the shaft and the motor base plate to descend in a predetermined distance.

A battery unit (not shown) (or simply a battery) provides power for operating the motor 420 and the controller (not shown).

The motor 420, the controller (not shown), and the battery unit (not shown) are included in the upper module 222. Since the solar panel 120 is installed to be inclined, and the solar panel cleaning apparatus 110 is disposed on the inclined solar panel 120, the weight of the whole or part of the solar panel cleaning apparatus 110 may concentrate excessively on the lower part of the solar panel cleaning apparatus 110. In such context, the solar panel cleaning apparatus 110 may be rendered to escape off the solar panel 120 by its own weight, or even the solar panel 120 may fall down or be displaced. To prevent such excessive weight concentration onto the lower part of the solar panel cleaning apparatus 110, the motor 420, the controller (not shown), and the battery unit (not shown) are included in the upper module 222.

FIG. 8 is a view illustrating a brush unit, a moving unit, and a lower module of a solar panel cleaning module according to an embodiment.

Referring to FIG. 8, according to an embodiment, the lower module 226 includes a shaft lift unit 830, a connector tension controller 850, and a connector 860, and the brush unit 224 includes a brush 810, a shaft 815, and a timing pulley 820. An apparatus moving unit 840 includes the second roller 530, a shaft 844, and a timing pulley 848.

The brush 810 contacts the solar panel 120 and removes foreign bodies from the surface of the solar panel 120. The brush 810 is disposed on the outer circumference of the shaft 815 and is rotated by the shaft 815. While rotating, the brush 810 fully or completely removes foreign bodies on the surface of the solar panel 120.

The shaft 815 receives a rotational force from the motor 420 and rotates. An end of the shaft 815, towards the upper module 222, is connected with the motor 420 through the coupling member 430 to receive a rotational force from the motor 420. The timing pulley 820 is formed at the other end of the shaft 815. The timing pulley 820 is connected with the timing pulley 848 of the apparatus moving unit 840 by the connector 860, transferring the rotational force to the apparatus moving unit 840. Since the rotational speed of the brush unit 224 is larger than the rotational speed of the second roller 530 in the apparatus moving unit 840, the timing pulley 820 is smaller in diameter than the timing pulley 848 of the apparatus moving unit 840.

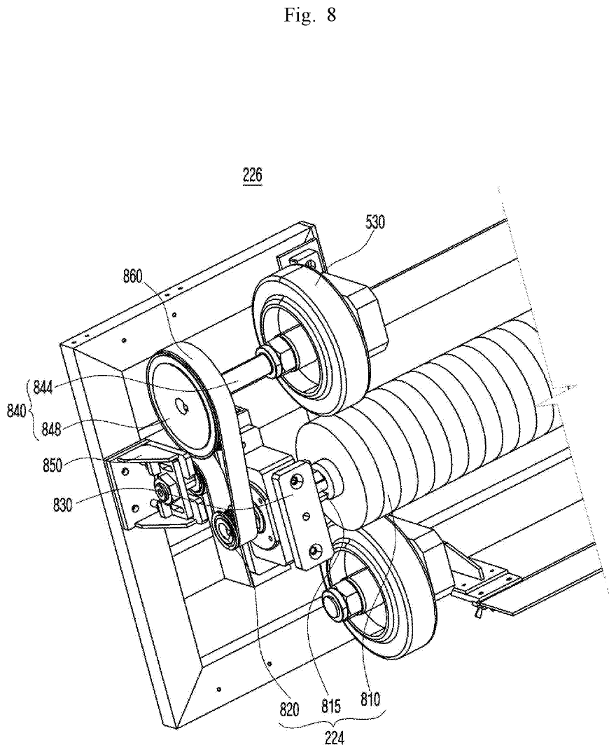

The shaft lift unit 830 has the shaft 815 penetrate between the brush 810 and the timing pulley 820, moving up or down the shaft 815 to allow the shaft 815 to approach the solar panel 120. The shaft lift unit 830 is described below in greater detail with reference to FIGS. 9A and 9B.

FIGS. 9A and 9B are views illustrating operations of a shaft lift according to an embodiment.

Referring to FIGS. 9A and 9B, the shaft lift unit 830 includes a first body part 910, a second body part 920, a coupling part 930, and a fastening plate 940.

The first body part 910 has the shaft penetrate and fastens the shaft and, as the second body part 920 moves, the first body part 910 approaches the solar panel 120 or the fastening plate 940. The first body part 910 itself does not move but comes close to the solar panel 120 as the fastening plate 940 connected with the first body part 910 moves.

The second body part 920 includes the coupling part 930 for coupling of an external coupling member (not shown), and the second body part 920 receives an external force by the coupling member (not shown) to move the fastening plate 940. The second body part 920 is spaced apart from the first body part 910 and is connected to the fastening plate 940 through the first body part 910 by a separate member, so that the second body part 920 is moved closer to the first body part 910 by an external force received from the coupling member (not shown) coupled to the coupling part 930. As the second body part 920 approaches the first body part 910, the fastening plate 940 connected with the second body part 920 is moved as well. Thus, the first body part 910 comes relatively close to the solar panel 120.

The fastening plate 940 is attached to the frame of the solar panel cleaning module 220 to fasten the shaft lift unit 830 to the frame of the solar panel cleaning module 220. As the shaft lift unit 830 is fastened to the frame of the solar panel cleaning module 220 by the fastening plate 940, if the second body part 920 moves towards the first body part 910, the first body part 910 may come closer to the solar panel 120. Thus, the shaft fastened to the first body part 910 and the brush around the shaft may come closer to the solar panel 120.

Although FIG. 8 illustrates that the shaft lift unit 830 is included in the lower module 226 alone, the shaft lift unit is included in each of the upper module 222 and the lower module 226 to move the whole shaft.

The apparatus moving unit 840 receives mechanical power from the brush unit 224 and moves the overall apparatus 110 including the solar panel cleaning module 220 on the solar panel 120.

The second roller 530 contacts the portion (e.g., the frame of the solar panel cleaning module 220), where no unit panel is disposed, of the surface where the solar cells or unit panels are formed, allowing the solar panel cleaning module 220 to move on the solar panel 120.

The timing pulley 848 is connected with the timing pulley 820 by the connector 860 and receives a rotational force from the timing pulley 820. The rotational force transferred to the timing pulley 848 is retransferred to the shaft 844.

The shaft 844 provides the rotational force received from the timing pulley 848 to the second roller 530. The shaft 844 has the timing pulley 848 at an end thereof facing the timing pulley 820 in the brush unit 224. The shaft 844 penetrates the second roller 530, which is placed in the position where it may contact the solar panel 120, and connects to the second roller 530. Thus, the shaft 844 receives a rotational force from the timing pulley 848 and provides the received rotational force to the second roller 530 to thereby allow the second roller 530 to move on the solar panel 120. As transfer of the rotational force to the second roller 530 allows the solar panel cleaning module 220 to move on the solar panel 120, the first roller 520 included in the upper module 222 may be moved as well.

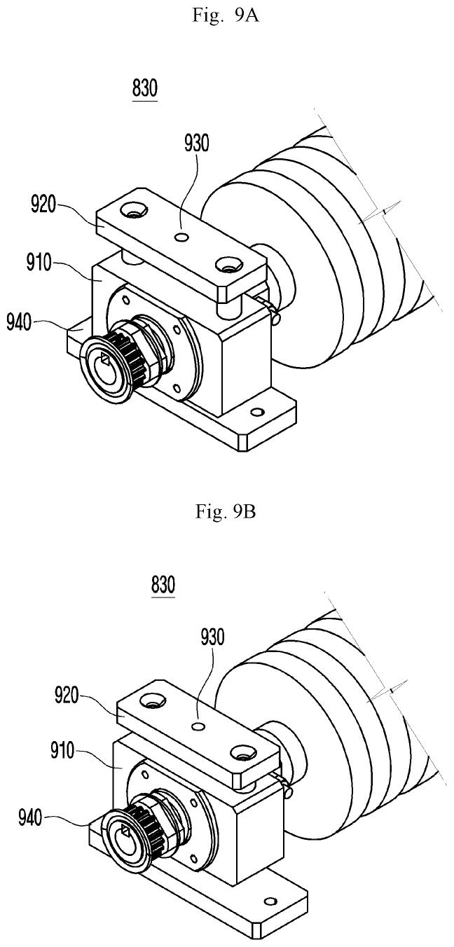

The connector tension controller 850 contacts the connector 860 to make up for a reduction in the tension of the connector 860 which occurs as the shaft 815 is moved by the shaft lift unit 830. As the distance between the timing pulleys 830 and 848 varies between when the shaft 815 is not moved by the shaft lift unit 830 (when the brush is not close to the solar panel 120) and when the shaft 815 is moved by the shaft lift unit 830 (when the brush becomes close to the solar panel 120), a tension gap occurs in the connector 860. The tension gap in the connector 860, particularly a reduction in tension, may result in a failure to fully transfer mechanical power to the apparatus moving unit 840. As a component for preventing such an occasion, the connector tension controller 850, when the shaft 815 is moved by the operation of the shaft lift unit 830, moves as far as, or further than the shaft 815 moves and thus contacts the connector 860. As the connector tension controller 850 deliberately contacts the connector 860 and applies pressure to the connector 860, allowing the tension of the connector 860 to remain without reduction. The connector tension controller 850 is described below with reference to FIG. 10.

FIG. 10 is a view illustrating a connector tension controller according to an embodiment.

A surface 1010 of the connector tension controller 850, which contacts the connector, is implemented to be flat to prevent damage to the connector 860. The connector tension controller 850 may also include a coupling part (not shown) for coupling with an external coupling member (not shown), and the surface 1010 contacting the connector is moved up or down by an external force transferred by the coupling member, thereby adjusting the tension of the connector 860.

Referring back to FIG. 8, the connector 860 connects the timing pulley 820 with the timing pulley 848 and transfers a rotational force of the timing pulley 820 to the timing pulley 848. As the connector 860 transfers the rotational force from the timing pulley 820 to the timing pulley 848, the connector 860 may be formed of a rubber material with a predetermined frictional force.

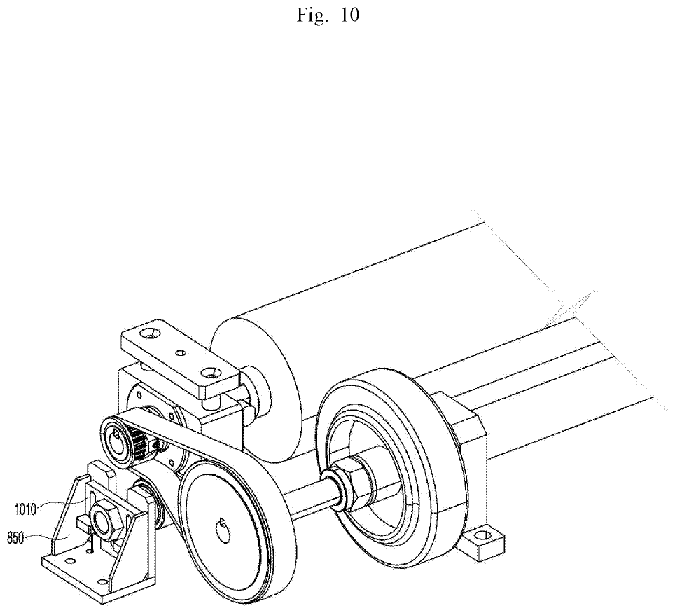

FIG. 11 is a view illustrating an example in which an assistant brush is coupled according to an embodiment.

The assistant brush 228 is coupled to the frame of the solar panel cleaning module 220 by a coupling plate 1110. As the coupling plate 1110 includes a fastening member 1112 and a fastening member introduction hole 1114 through which the fastening member 1112 may elevate or lower, the coupling plate 1110 and the assistant brush 228 connected with the fastening plate 940 may be moved up or down by an external force. The ascent or descent of the assistant brush 228 varies the distance between the assistant brush 228 and the solar panel 120. Like the brush 810, the assistant brush 228 may also be worn. Thus, after a predetermined time of use, the assistant brush 228 may experience a lowering in the capability of removing foreign bodies. The assistant brush 228, along with the brush 810, approaches the solar panel 120 as the coupling plate 1110 ascends or descends and, thus, the assistant brush's capability of removing foreign bodies may remain at a predetermined level.

Rather than directly attached to the coupling plate 1110, the assistant brush 228 is connected to the coupling plate 1110 via a plate connector 1120 and a fastening member 1130. The plate connector 1120 is attached to the coupling plate 1110, and the assistant brush 228 is fastened to a portion of the plate connector 1120 by the fastening member 1130. Thus, the assistant brush 228 may be easily removed from the plate connector 1120 by removing the fastening member 1130 and, thus, the assistant brush 228 may be easily replaced.

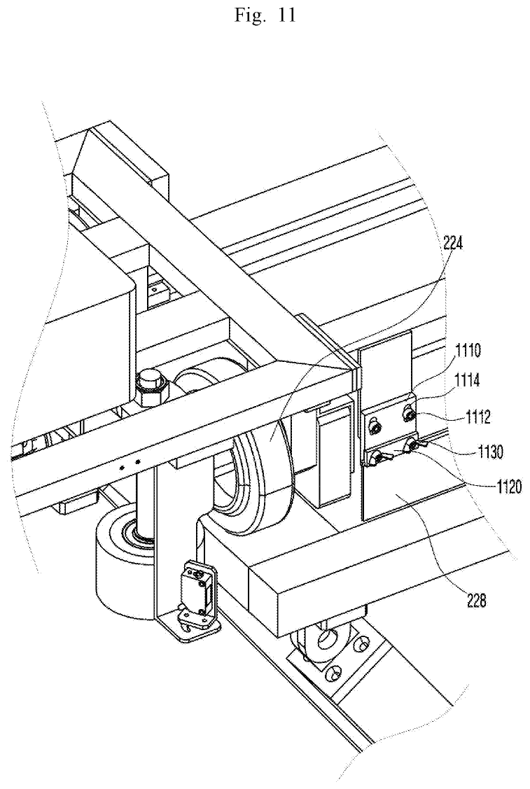

FIG. 12 is a view illustrating a charging terminal according to an embodiment.

The charging terminal 140 is formed on the frame 135 of the station which may contact a metal pad 1224 that is connected with the battery 320 of the solar panel cleaning apparatus 110 to receive power from an external power source and to transfer the power to the battery 320. The charging terminal 140 steadily or periodically receives power from the external power source and supplies power to the metal pad of the solar panel cleaning apparatus, which contacts the charging terminal 140. Thus, the solar panel cleaning apparatus 110 may move to the station 130 to thereby receiving power from the charging terminal 140 and charge the battery 320. As such, the solar panel cleaning apparatus 110 may operate, with the battery 320 easily charged until the lifetime of the battery 320 ends. If the lifetime of the battery 320 ends, the battery 320 may be easily removed and replaced even without disassembling the solar panel cleaning apparatus 110.

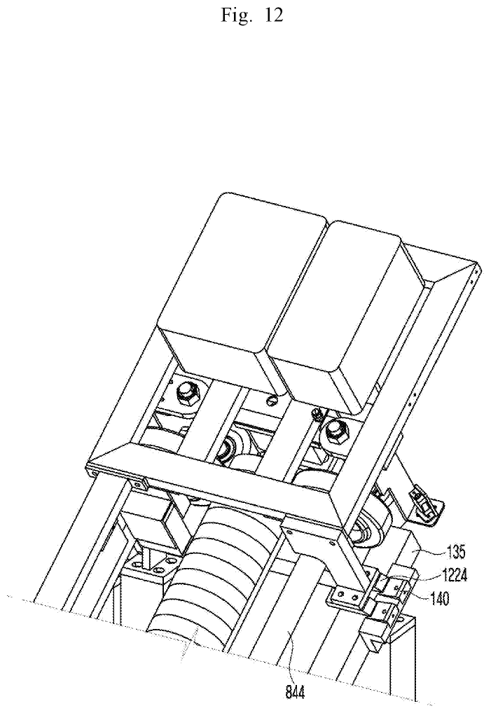

FIG. 13 is a view illustrating a solar panel state diagnosis system according to an embodiment.

Referring to FIG. 13, a solar panel state diagnosis system 1300 includes an inverter 1320, a solar panel cleaning robot 1330 (simply referred to as a ‘cleaning robot’), and a diagnosis server 1340.

A solar panel array 1310 (simply referred to hereinafter as a ‘panel array’) is subject to cleaning by the cleaning robot 1330, and the solar panel array 1310 includes a group of a plurality of plate- or board-shaped unit panels 1312 each of which constitutes a module with a plurality of solar cells. The panel array 1310 may have the plurality of unit panels 1312 arranged in a row, and a panel line 1314 is formed between one unit panel 1312 and another. The size and shape of the panel array 1310 differs depending on the place where it is installed or the shape of the solar cell. Typically, the panel array 1310, along with a structure, may be installed on the building roof or mountain slope. The panel array 1310 may be inclined at a predetermined angle and is supported by a supporting structure.

By the nature of the panel array 1310 being installed outside, various foreign bodies may build up on the surface of the panel array 1310. This may lower the amount of light incident onto the panel array 1310, deteriorating power generation efficiency. The amount of light incident onto the panel array 1310 may increase or decrease depending on weather conditions, such as solar irradiance, temperature, illuminance, and rain in the environment where the panel array 1310 is installed. As such, since the power generation efficiency may be varied depending on the presence of foreign bodies on the surface of the panel array 1310 and the environment where the panel array 1310 is installed, it is critical to diagnose and address any issue with the panel array 1310. According to an embodiment, there is disclosed a solar panel state diagnosis system 1300 capable of diagnose the state of the panel array 1310 in an efficient manner.

As electric current is fed to the panel array 1310 by a separate power supply (not shown), the inverter 1320 receives direct current (DC) power through a negative (−) terminal 1322, a positive (+) terminal 1324, and a lead line 1326 connected with the two terminals 1322 and 1324 and converts the DC power into alternating current (AC) power. The AC power output from the inverter 1320 is supplied to power consuming devices or facilities.

The cleaning robot 1330 drives on the surface of the panel array 1310 while removing foreign bodies on the panel array 1310. The cleaning robot 1330 may include a plurality of sensors (not shown). The cleaning robot 1330 may sense or obtain state information (e.g., the strength of electric and magnetic field, temperature, or solar irradiance) for the panel array 1310 using the plurality of sensors (not shown).

The cleaning robot 1330 may wiredly or wirelessly communicate with the diagnosis server 1340 via a network and transmit the state information for the panel array 1310 obtained by the plurality of sensors (not shown) to the diagnosis server 1340. The cleaning robot 1330 may detect state information, e.g., the strength of electric field and magnetic field, temperature, and solar irradiance. The diagnosis server 1340 may receive state information (e.g., the strength of electric field and magnetic field, temperature, and solar irradiance) for the panel array 1310 which has been detected by the cleaning robot 1330 and analyze the state information, thereby diagnosing each unit panel 1312 constituting the panel array 1310.

The sensor module 130 may transmit the detected strength of electric field and magnetic field of the panel array 1310 to the diagnosis server 1340, and the diagnosis server 1340 may analyze the strength of electric field and magnetic field and provide the user with the number of unit panels 1312 constituting the panel array 1310 and the array of the unit panels 1312.

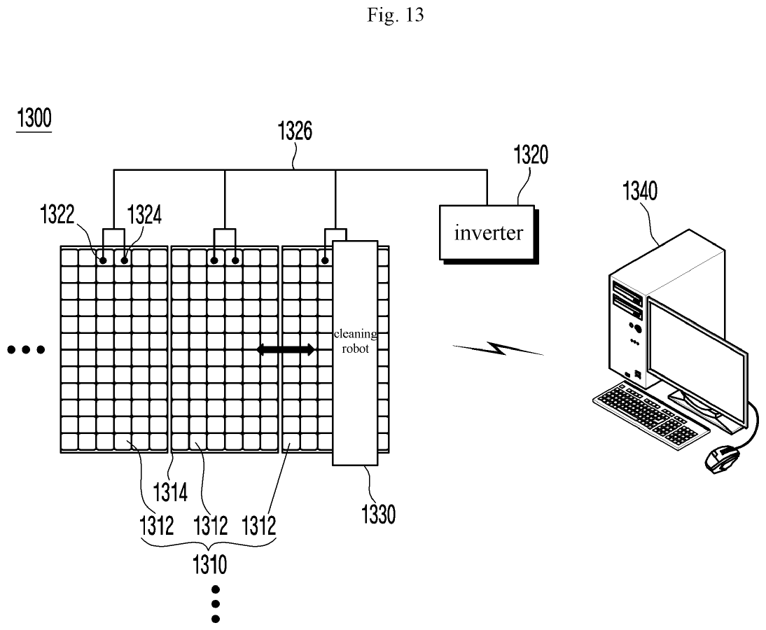

The cleaning robot 1330 is described below in detail with reference to FIGS. 14, 16, and 17.

The diagnosis server 1340 receives the strength of electric field and magnetic field of the panel array 1310 from the cleaning robot 1330 and provides a user interface (UI) to display the number of unit panels 1312 constituting the panel array 1310 and the array of the unit panels 1312 to the user.

The diagnosis server 1340 receives the state information (e.g., the strength of electric field and magnetic field, temperature, and solar irradiance) from the cleaning robot 1330 and provides mapping information regarding whether the unit panels 1312 are normal or abnormal to the UI screen so that the user may grasp the state of the unit panels 1312 constituting the panel array 1310.

The diagnosis server 1340 may receive state information (e.g., the strength of electric field and magnetic field, temperature, and solar irradiance) for the panel array 1310 which the cleaning robot 1330 detects while driving on the surface of the panel array 1310 and performs comparison and analysis of state information (e.g., the strength of electric field and magnetic field, temperature, and solar irradiance) between two adjacent ones of the unit panels 1312, thereby determining whether the unit panels 1312 work properly.

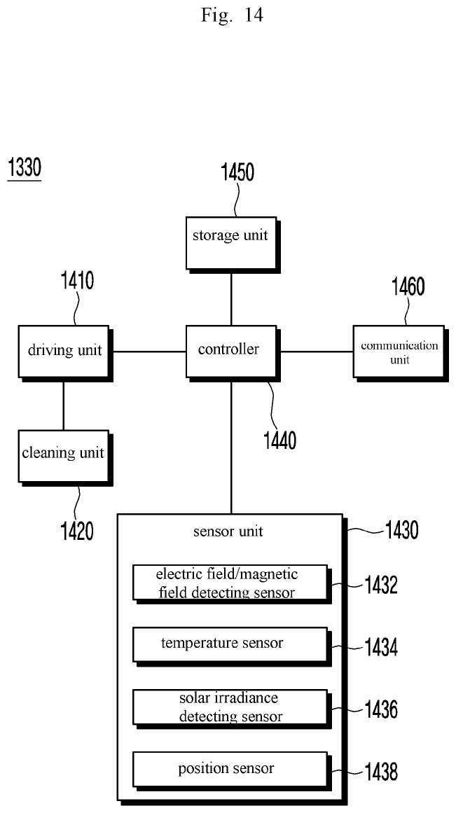

The operation of the diagnosis server 1340 is described below with reference to FIG. 15.

FIG. 14 is a view illustrating a configuration of a solar panel cleaning robot according to an embodiment.

Referring to FIG. 14, a cleaning robot 1330 includes a driving unit 1410, a cleaning unit 1420, a sensor unit 1430, a controller 1440, a storage unit 1450, and a communication unit 1460.

The driving unit 1410 drives the cleaning robot 1330 to move on the panel array 1310 while cleaning the surface of the panel array 1310 and sensing the strength of electric field and magnetic field, temperature, and solar irradiance of the panel array 1310 using the sensor unit 1430.

The driving unit 1410 may move the cleaning robot 1330 on the surface of the panel array 1310 under the control of the controller 1440. When the cleaning robot 1330 arrives at a distal end of the panel array 1310, the driving unit 1410 enables the cleaning robot 1330 to return to its initial position. The driving unit 1410 includes a moving member (not shown), and the driving unit 1410 enables the cleaning robot 1330 to move along the panel array 1310 using the moving member (not shown). The moving member (not shown) may be, or include, a plurality of wheels, but not limited thereto. For example, any other various members may be used as the moving member as long as they enable the cleaning robot 1330 to move along the panel array 1310. The driving unit 1410 may receive mechanical power from a separate driving motor (not shown) provided in the cleaning robot 1330, thereby allowing the cleaning robot 1330 to move along the panel array 1310.

The cleaning unit 1420 may be operated along with the driving unit 1410. The cleaning unit 1420 drives the cleaning robot 1330 to remove foreign bodies on the surface of the panel array 1310 while the cleaning robot 1330 is moved along the panel array 1310 by the driving unit 1410.

The cleaning unit 1420 cleans the surface of the panel array 1310 under the control of the controller 1440. When the cleaning robot 1330 arrives at the distal end of the panel array 1310, the cleaning unit 1420 may stop operation and, when the cleaning robot 1330 is returned back to its initial position by the driving unit 1410, the cleaning unit 1420 resumes operation. The cleaning unit 1420 includes a brush (not shown) to be able to effectively remove foreign bodies from the surface of the panel array 1310. The cleaning unit 1420 removes foreign bodies on the surface of the panel array 1310 using the brush (not shown). The cleaning unit 1420 receives mechanical power from a separate motor for the brush (not shown) provided in the cleaning robot 1330, allowing the cleaning robot 1330 to remove foreign bodies from the surface of the panel array 1310.

The cleaning unit 1420 may include a foreign body detecting sensor (not shown) that may detect foreign bodies on its own, and the cleaning unit 1420 provides obtained sensing information to the controller 1440. The cleaning unit 1420 may be implemented to operate or stop operation depending on whether there are foreign bodies on the surface of the panel array 1310.

The sensor unit 1430 detects, senses, or obtains information about, the strength of electric field and magnetic field, temperature, and solar irradiance of the panel array 1310 and provides the sensing information to the controller 1440. The strength of electric field and magnetic field, temperature, and solar irradiance information or data obtained by the sensor unit 1430 may be transmitted to the diagnosis server 1340, and the diagnosis server 1340 may determine the number and array of the unit panels 1312 constituting the panel array 1310 and whether the unit panels 1312 are normal or abnormal.

The sensor unit 1430 includes an electric field/magnetic field detecting sensor 1432, a temperature sensor 1434, a solar irradiance detecting sensor 1436, and a position sensor 1438.

The electric field/magnetic field detecting sensor 1432 detects the strength of electric field and magnetic field of the unit panels 1312 formed by current flowing through the negative and positive terminals 1322 and 1324 connected to each unit panel 1312 and the lead line 1326 connected to the terminals 1322 and 1324.

The negative and positive terminals 1322 and 1324 are provided on one side surface of the unit panel 1312, and the negative and positive terminals 1322 and 1324 are connected with the lead line 1326. The electric field/magnetic field detecting sensor 1432 detects the strength of electric field and magnetic field of the unit panels 1312 formed by current flowing through the lead line 1326. As a current is rendered to flow through the lead line 1326 by a separate power supply (not shown), an electric field and magnetic field is produced from the unit panel 1312, and the electric field/magnetic field detecting sensor 1432 detects the electric field and magnetic field and provides the detected electric field and magnetic field to the controller 1440. The electric field/magnetic field detecting sensor 1432 provides electric field and magnetic field strength information to the controller 1440, and the electric field and magnetic field strength information may be transmitted to the diagnosis server 1340 via the communication unit 1460, so that the diagnosis server 1340 may diagnose the unit panels 1312 as to the number and array of the unit panels 1312 constituting the panel array 1310 and whether the unit panels 1312 work properly.

As set forth above, the panel array 1310 includes a plurality of unit panels 1312, and two adjacent ones of the unit panels 1312 are divided from each other by the panel line 1314. The strength of electric field and magnetic field may be maximum at the portion of the unit panels 1312 where the negative and positive terminals 1322 and 1324 are positioned and may be minimum at the panel line 1314. If the unit panel 1312 has foreign bodies on its surface or is damaged or open-circuited, the strength of electric field and magnetic field may vary. The diagnosis server 1340 may receive the strength of electric field and magnetic field of the unit panel 1312 from the communication unit 1460 of the cleaning robot 1330 and perform comparison and analysis of the strength of electric field and magnetic field of the unit panel 1312 before an error occurs, the strength of electric field and magnetic field of the unit panel 1312 after the error occurs, and the strength of electric field and magnetic field of another unit panel 1312 adjacent to the unit panel 1312, thereby determining whether the unit panel 1312 has an error or abnormality and, if so, the cause of the error or abnormality.

Since the strength of electric field and magnetic field may be maximum at the portion of the unit panels 1312 where the negative and positive terminals 1322 and 1324 are positioned and may be minimum at the panel line 1314, another unit panel 1312 adjacent to the unit panel 1312 may be identified or differentiated by the strength of electric field and magnetic field. For example, the diagnosis server 1340 which receives the strength of electric field and magnetic field detected by the electric field/magnetic field detecting sensor 1432 may create a pattern or graph for the strength of electric field and magnetic field of the unit panel 1312 and may differentiate another unit panel 1312 adjacent to the unit panel 1312 based on the feature that the strength of electric field and magnetic field of the unit panel 1312 is maximum at the portion where the negative and positive terminals 1322 and 1324 are positioned and is minimum at the panel line 1314, thereby grasping the number and array of the unit panels 1312 constituting the panel array 1310.

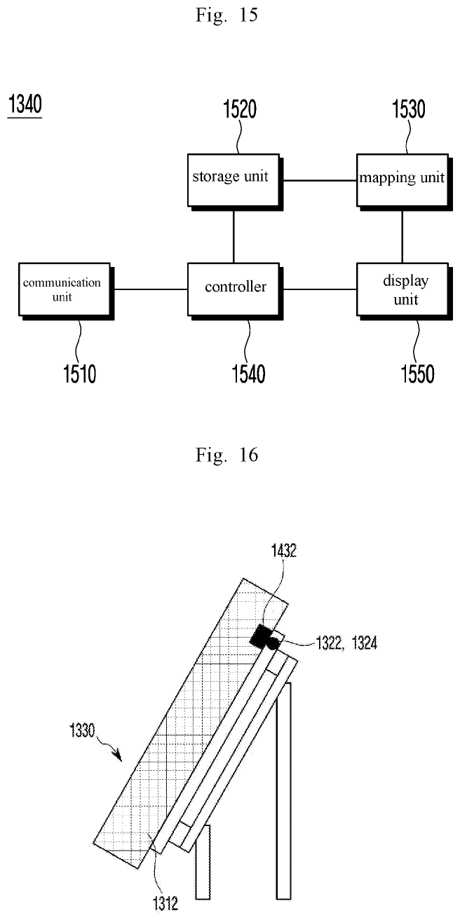

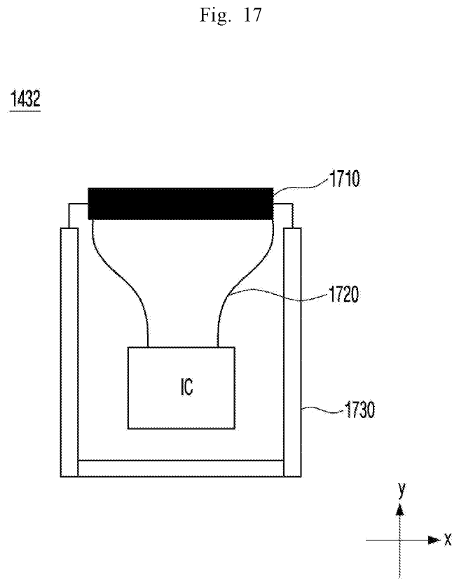

The position of the electric field/magnetic field detecting sensor 1432 in the cleaning robot 1330 and the structure of the electric field/magnetic field detecting sensor 1432 are described below in detail with reference to FIGS. 16 and 17.

FIG. 16 is a view illustrating an example in which a solar panel cleaning robot is mounted on a solar panel according to an embodiment. FIG. 17 is a view illustrating a configuration of an electric field and magnetic field sensor of a solar panel cleaning robot according to an embodiment.

Referring to FIG. 16, the cleaning robot 1330 may be configured with a larger width than that of the unit panel 1312. Thus, the cleaning robot 1330 mounted on the unit panel 1312 may stably move along the unit panel 1312.

As described above in connection with FIG. 15, the cleaning robot 1330 includes the electric field/magnetic field detecting sensor 1432 and may sense the strength of electric field and magnetic field of the unit panel 1312 using the electric field/magnetic field detecting sensor 1432. The electric field/magnetic field detecting sensor 1432 may be disposed on the bottom surface (e.g., the surface of the cleaning robot 1330 facing the surface of the unit panel 1312) of the cleaning robot 1330 considering the position where it contacts the negative and positive terminals 1322 and 1324 provided on the surface of the unit panel 1312. Thus, when the cleaning robot 1330 is moved along the unit panel 1312 by the driving unit 1410, the electric field/magnetic field detecting sensor 1432 may come in contact with the negative and positive terminals 1322 and 1324 provided in each unit panel 1312, thereby sensing the strength of electric field and magnetic field of each unit panel 1312.

Referring to FIG. 17, the electric field/magnetic field detecting sensor 1432 includes a magnetic induction plate 1710, a current measuring unit 1720, and a shielding lead plate 1730.

The magnetic induction plate 1710 is configured to induce a magnetic field around to allow the magnetic field formed over the unit panel 1312 to be sensed by the current flowing through the lead line 1326. An electrode (not shown) and the current measuring unit 1720 are coupled to the bottom surface (in the direction of the −y axis) of the magnetic induction plate 1710. The magnetic induction plate 1710 may be a copper plate formed of copper (Cu) but is not limited thereto. For example, the magnetic induction plate 1710 may be formed of a high-conductive material, such as aluminum (Al), tungsten (W), or silver (Ag). The magnetic induction plate 1710 may be 100 mm×70 mm in size and 1.6 t in weight, but is not limited thereto. The size and weight of the magnetic induction plate 1710 may be varied depending on the shape of the cleaning robot 1330.

The current measuring unit 1720 may obtain the strength of the current by inputting a magnetic field value obtained by the magnetic field applied to the magnetic induction plate 1710 to a preset equation.

The shielding lead plate 1730 protects the internal components of the electric field/magnetic field detecting sensor 1432 and supports the magnetic induction plate 1710. The shielding lead plate 1730 may also shield off the magnetic field induced from, e.g., the internal component of the cleaning robot 1330. The shielding lead plate 1730 may be formed of lead (Pb), but is not limited thereto. For example, the shielding lead plate 1730 may also be formed of glass, resin, or silicone.

Referring back to FIG. 14, the temperature sensor 1434 measures the temperature of the panel array 1310.

The temperature sensor 1434 measures the temperature of the panel array 1310.

The temperature sensor 1434 may be provided in a position proper to measure the temperature of the panel array 1310. The temperature sensor 1434 detects the temperature of the surface of the panel array 1310 and provides the detected temperature to the controller 1440. The temperature sensor 1434 provides the temperature data for the surface of the panel array 1310 to the controller 1440, and the temperature data may be transmitted to the diagnosis server 1340 via the communication unit 1460, so that the diagnosis server 1340 may diagnose each of the unit panels 1312 constituting the panel array 1310.

The solar irradiance detecting sensor 1436 measures the solar irradiance of sunlight incident onto the panel array 1310.

The solar irradiance detecting sensor 1436 may be configured in a form appropriate for measuring the solar irradiance of sunlight incident onto the panel array 1310 (e.g., the solar irradiance detecting sensor 1436 may be oriented so that its light incident surface faces the sun) and in a position appropriate for measuring the solar irradiance of sunlight incident onto the panel array 1310 inside the cleaning robot 1330, and the solar irradiance detecting sensor 1436 detects the solar irradiance of sunlight incident onto the surface of the panel array 1310 and provides the detected solar irradiance to the controller 1440. The solar irradiance detecting sensor 1436 provides the solar irradiance data for sunlight incident onto the panel array 1310 to the controller 1440, and the solar irradiance data may be transmitted to the diagnosis server 1340 via the communication unit 1460, so that the diagnosis server 1340 may determine an abnormality of each of the unit panels 1312 constituting the panel array 1310.

The position sensor 1438 detects the position of the cleaning robot 1330.

The position sensor 1438 detects the initial position of the cleaning robot 1330 and provides the initial position to the controller 1440 so that the controller 1440 may control the driving unit 1410 and the cleaning unit 1420.

The position sensor 1438 detects whether the cleaning robot 1330 arrives at the distal end of the panel array 1310. When the cleaning robot 1330 arrives at the distal end of the panel array 1310, the position sensor 1438 detects the arrival at the distal end and provides the detected information or data to the controller 1440 so that the controller 1440 may control the driving unit 1410 and the cleaning unit 1420.

The controller 1440 may control the operation of each component in the cleaning robot 1330 to thereby allow the cleaning robot 1330 to move along the panel array 1310 while cleaning the surface of the panel array 1310 and sensing the strength of electric field and magnetic field, temperature, and solar irradiance of the panel array 1310.

The controller 1440 controls the operation of the driving unit 1410 based on the sensing value of the position sensor 1438. Upon detecting the initial position of the cleaning robot 1330 by the position sensor 1438, the controller 1440 operates the driving unit 1410 according to the sensing value, allowing the cleaning robot 1330 to move on the surface of the panel array 1310.

As described above, when the cleaning robot 1330 arrives at the distal end of the panel array 1310, the controller 1440 receives the sensing value from the position sensor 1438. The controller 1440 controls the driving unit 1410 to stop further moving based on the sensing value, preventing the cleaning robot 1330 from falling off the panel array 1310. The controller 1440 controls the operation mechanism of the driving unit 1410 in an opposite way so as to return the cleaning robot 1330, which has arrived at the distal end of the panel array 1310, to the initial position.

The controller 1440 controls the operation of the cleaning unit 1420 based on the sensing value of the position sensor 1438. Upon detecting the initial position of the cleaning robot 1330 by the position sensor 1438, the controller 1440 operates the cleaning unit 1420 according to the sensing value, allowing the cleaning robot 1330 to remove foreign bodies from the surface of the panel array 1310 while moving along the surface of the panel array 1310.

When the cleaning robot 1330 arrives at the distal end of the panel array 1310, the controller 1440 receives the sensing value from the position sensor 1438 and controls the cleaning unit 1420 to stop further operation.

As set forth above, the cleaning unit 1420 may include a foreign body detecting sensor (not shown) that may sense foreign bodies on its own. If foreign bodies on the surface of the panel array 1310 are detected by the foreign body detecting sensor (not shown), the controller 1440 receives the sensing value from the foreign body detecting sensor (not shown) and controls the cleaning unit 1420 to operate.

The controller 1440 transmits the strength of electric field and magnetic field, temperature, and solar irradiance data for the panel array 1310 received from the sensor unit 1430 to the storage unit 1450. The controller 1440 classifies, per time, the electric field and magnetic field strength, temperature, and solar irradiance data for the panel array 1310 received from the sensor unit 1430 and transmit the classified data or information to the storage unit 1450. The controller 1440 controls the storage unit 1450 to allow data stored in the storage unit 1450 to be transmitted to the diagnosis server 1340 by receiving a signal from the communication unit 1460 through the diagnosis server 1340.

The controller 1440 receives the signal output from the communication unit 1460 to be able to transmit the electric field and magnetic field data, temperature, and solar irradiance data for the panel array 1310 stored in the storage unit 1450 to the diagnosis server 1340. The controller 1440 controls the storage unit 1450 to allow the data in the storage unit 1450 to be transmitted to the diagnosis server 1340 by receiving the signal from the diagnosis server 1340 through the communication unit 1460.

The storage unit 1450 receives from the controller 1440 and stores the electric field and magnetic field data, temperature, and solar irradiance data for the panel array 1310 which have already been measured several times by the cleaning robot 1330 before (or at the initial stage of) occurrence of an error or abnormality, a difference in electric field and magnetic field strength between the unit panel 1312 and its adjacent unit panel 1312, and the temperatures of the unit panel 1312 and its adjacent unit panel 1312. The storage unit 1450 stores the electric field and magnetic field data, temperature, and solar irradiance data for the panel array 1310 provided from the sensor unit 1430 to the controller 1440. The storage unit 1450 recognizes an instruction from the controller 1440 to allow the electric field and magnetic field data, temperature, and solar irradiance data for the panel array 1310 to be transmitted to the diagnosis server 1340 under the control of the controller 1440.

The communication unit 1460 receives a signal from the diagnosis server 1340 and transmits the signal to the controller 1440 so that the controller 1440 may transmit the electric field and magnetic field data, temperature, and solar irradiance data for the panel array 1310 stored in the storage unit 1450 to the diagnosis server 1340. The communication unit 1460 may be configured as, e.g., an infrared (IR) sensor or a wireless communication module to allow the cleaning robot 1330 to communicate with the diagnosis server 1340.

FIG. 15 is a view illustrating a configuration of a diagnosis server according to an embodiment.

The diagnosis server 1340 includes a communication unit 1510, a storage unit 1520, a mapping unit 1530, a controller 1540, and a display unit 1550.

The communication unit 1510 transmits a signal output from the controller 1540 to the cleaning robot 1330 and receives the electric field and magnetic field data, temperature, and solar irradiance data for the panel array 1310 from the cleaning robot 1330. Likewise, the communication unit 1510 of the diagnosis server 1340 may be configured as, e.g., an IR sensor or wireless communication module to allow the diagnosis server 1340 to communicate with the cleaning robot 1330.

The storage unit 1520 stores the electric field and magnetic field data, temperature, and solar irradiance data for the panel array 1310 received from the cleaning robot 1330. The storage unit 1520 may classify, per time, the electric field and magnetic field data, temperature, and solar irradiance data for the panel array 1310 and store the classified data.

The mapping unit 1530 visualizes or represents the number and array of the unit panels 1312 constituting the panel array 1310 in a diagram or image to allow the user to recognize or perceive. As described above in connection with FIGS. 13 and 14, the panel array 1310 includes a plurality of unit panels 1312 and each of the unit panels 1312 and its adjacent unit panel 1312 may be divided from each other by the electric field and magnetic field strength data. For example, the electric field and magnetic field strength of the unit panel 1312 is maximum at the portion where the negative and positive terminals 1322 and 1324 are provided and minimum at the panel line 1314 which is the border between the unit panel 1312 and its adjacent unit panel 1312. Thus, the controller 1540 may be configured to allow the electric field and magnetic field strength of the panel array 1310 to have a preset pattern. The controller 1540 may analyze a preset pattern for the panel array 1310 to thereby divide the unit panel 1312 and its adjacent unit panel 1312, thereby grasping the number and array of the unit panels 1312 constituting the panel array 1310. The mapping unit 1530 visualizes or represents in a diagram or image the data for the number and array of the unit panels 1312 received from the controller 1540, thereby creating a configuration map for the solar power generation facility. The mapping unit 1530 provides the created configuration map to the controller 1540.

The controller 1540 determines the number and array of the unit panels 1312 and whether the unit panels 1312 are normal or abnormal based on the electric field and magnetic field data, temperature, and solar irradiance data for the panel array 1310 stored in the storage unit 1520.

As described above, the controller 1540 configures the electric field and magnetic field strength of the panel array 1310 stored in the storage unit 1520 into a preset pattern, analyzes the pattern, and transmits the number and array of the unit panels 1312 constituting the panel array 1310 to the mapping unit 1530.

The controller 1540 compares the respective electric field and magnetic field strength patterns of the unit panel 1312 where an error occurs and its adjacent unit panel 1312, thereby determining whether there is an abnormality. If the respective electric field and magnetic field strength patterns of the unit panel 1312 with an error and its adjacent unit panel 1312 are identical to each other, the controller 1540 determines that this error results from influence by the temperature or solar irradiance. Thus, the controller 1540 transmits data for informing the user that the error comes from influence by the temperature or solar irradiance to the display unit 1550.

If the respective electric field and magnetic field strength patterns of the unit panel 1312 with an error and its adjacent unit panel 1312 are different from each other, the controller 1540 compares the temperature of the unit panel 1312 with the error and the temperature of its adjacent unit panel 1312. If the temperature of the unit panel 1312 with the error and the temperature of its adjacent unit panel 1312 differ from each other, and the temperature difference is a preset value or more, the controller 1540 calculates the difference between the respective electric field and magnetic field strengths of the unit panel 1312 with the error and its adjacent unit panel 1312 and compares the electric field and magnetic field strength difference with data pre-stored in the storage unit 1520. If the difference in electric field and magnetic field strength between the unit panel 1312 with the error and the adjacent unit panel 1312 is identical to the data pre-stored in the storage unit 1520, the controller 1540 converts the data from which the user may recognize the cause of the error and transmits the converted data to the display unit 1550. The controller 1540 may determine that the error is caused by bird excreta or relatively large foreign bodies on the surface of the unit panel 1312, e.g., for the following reasons. If bird excreta or relatively large foreign bodies are on the surface of the unit panel 1312, the amount of light incident onto the unit panel 1312 may be prominently reduced so that an electric potential difference occurs between the unit panel 1312 with the foreign bodies or bird excreta and its adjacent unit panel 1312 which is clean. Such an electric potential difference causes current to concentrate on the unit panel 1312 with the foreign bodies, causing heat and raising the temperature. Further, the output values from the negative and positive terminals 1322 and 1324 of the unit panel 1312 with the foreign bodies are reduced, resultantly decreasing the strength of electric field and magnetic field produced from the unit panel 1312 with the foreign bodies.

If the difference in electric field and magnetic field strength between the unit panel 1312 with the error and the adjacent unit panel 1312 differs from the data pre-stored in the storage unit 1520, the controller 1540 analyzes the per-time electric field and magnetic field strength of the unit panel 1312 with the error. If the per-time difference in electric field and magnetic field strength of the unit panel 1312 with the error is a preset value or more, the controller 1540 compares the difference with data pre-stored in the storage unit 1520. If the per-time difference in the electric field and magnetic field strength of the unit panel 1312 is the same as the data pre-stored in the storage unit 1520, the controller 1540 may convert the data so that the user may recognize the cause of the error and transmit the converted data to the display unit 1550. In such a case, the controller 1540 may determine that the unit panel 1312 itself has been broken or open-circuited. Since the panel array 1310 is typically installed outdoors, the panel array 1310 may be cracked or open-circuited by weather disasters or external impacts. In this case, the electric field and magnetic field strength of the unit panel 1312 may show a noticeable difference from the electric field and magnetic field strength of its adjacent unit panel 1312 and so is from the electric field and magnetic field strength before the crack or open circuit occurs.

Further, if foreign bodies build up on the unit panel 1312, the controller 1540 may transmit a signal to the communication unit 1510 so that the communication unit 1510 may transfer the signal to the communication unit 1460 of the cleaning robot 1330. The controller 1440 of the cleaning robot 1330, receiving the signal from the diagnosis server 1340, controls the driving unit 1410 and the cleaning unit 1420 to operate to remove the foreign bodies from the surface of the unit panel 1312. If the foreign bodies are removed by the driving unit 1410 and the cleaning unit 1420, the controller 1440 of the cleaning robot 1330 may transmit a signal to the communication unit 1460 so that the communication unit 1460 may transfer the signal to the communication unit 1510 of the diagnosis server 1340. The controller 1540 of the diagnosis server 1340, receiving the signal from the cleaning robot 1330, converts the data into a form that the user may recognize and transmits the converted data to the display unit 1550.

The display unit 1550 displays the solar power generation system mapped by the mapping unit 1530 and displays information received from the controller 1540 so that the user may easily figure out the position of the unit panel 1312 and the cause of the error. The display unit 1550 may be, or include, a liquid crystal display (LCD) monitor, a touchscreen monitor, or any kind of device capable of displaying information.

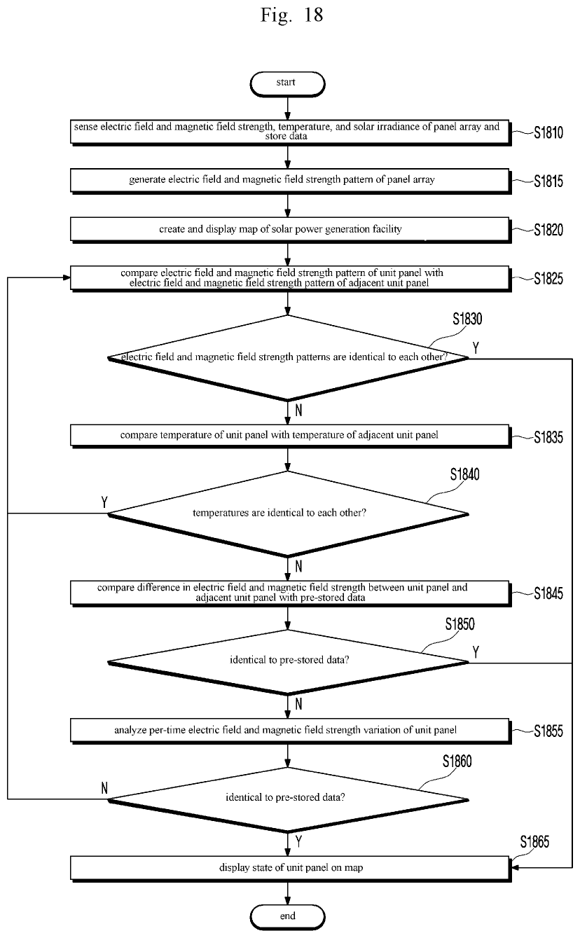

FIG. 18 is a flowchart illustrating a method of diagnosing abnormalities in solar panels by a solar panel state diagnosis system according to an embodiment.

A method of determining an abnormality of the unit panel 1312 by the solar panel state diagnosis system 1300 has been described above in connection with FIGS. 13 to 17 and no more detailed description thereof is given below.

The cleaning robot 1330 senses the strength of electric field and magnetic field, temperature, and solar irradiance of the panel array 1310 and stores the sensing data (S1810).

The diagnosis server 1340 generates a pattern of the electric field and magnetic field strength of the panel array 1310 (S1815).

The diagnosis server 1340 creates a map for the solar power generation facility and displays the created map (S1820). The diagnosis server 1340 displays, e.g., the number and array of the plurality of unit panels 1312 constituting the panel array 1310 based on the electric field and magnetic field strength pattern of the panel array 1310.

The diagnosis server 1340 compares the electric field and magnetic field strength pattern of the unit panel 1312 with the electric field and magnetic field strength pattern of its adjacent unit panel 1312 (S1825).

The diagnosis server 1340 determines whether the electric field and magnetic field strength pattern of the unit panel 1312 is identical to the electric field and magnetic field strength pattern of its adjacent unit panel 1312 (S1830). If the electric field and magnetic field strength pattern of the unit panel 1312 is identical to the electric field and magnetic field strength pattern of the adjacent unit panel 1312, the diagnosis server 1340 determines that a difference in the state of the unit panel 1312 results from the solar irradiance, temperature, or weather environment and displays the state of the unit panel 1312 (or the difference in the state of the unit panel 1312) on the map (S1865).

If the electric field and magnetic field strength pattern of the unit panel 1312 differs from the electric field and magnetic field strength pattern of the adjacent unit panel 1312, the diagnosis server 1340 compares the temperature of the unit panel 1312 with the temperature of the adjacent unit panel 1312 (S1835).

The diagnosis server 1340 determines whether the temperature of the unit panel 1312 is identical to the temperature of the adjacent unit panel 1312 (S1840). If the temperature of the unit panel 1312 is identical to the temperature of the adjacent unit panel 1312, the diagnosis server 1340 compares the electric field and magnetic field strength pattern of the unit panel 1312 with the electric field and magnetic field strength pattern of the adjacent unit panel 1312.

If the temperature of the unit panel 1312 differs from the temperature of the adjacent unit panel 1312, the diagnosis server 1340 performs comparison regarding the difference between the electric field and magnetic field strength of the unit panel 1312 and the electric field and magnetic field strength of the adjacent unit panel 1312 (S1845).

The diagnosis server 1340 determines whether the difference between the electric field and magnetic field strength of the unit panel 1312 and the electric field and magnetic field strength of the adjacent unit panel 1312 is identical to pre-stored data (S1850). If the difference between the electric field and magnetic field strength of the unit panel 1312 and the electric field and magnetic field strength of the adjacent unit panel 1312 is identical to the pre-stored data, the diagnosis server 1340 displays the state of the unit panel 1312 with an error on the map so that the user may recognize it (S1865).

If the difference between the electric field and magnetic field strength of the unit panel 1312 and the electric field and magnetic field strength of the adjacent unit panel 1312 differs from the pre-stored data, the diagnosis server 1340 analyzes per-time electric field and magnetic field strength variations (S1855).

The diagnosis server 1340 determines whether the per-time electric field and magnetic field strength variation of the unit panel 1312 is identical to pre-stored data (S1860). If the per-time electric field and magnetic field strength variation of the unit panel 1312 differs from the pre-stored data, the diagnosis server 1340 compares the electric field and magnetic field strength pattern of the unit panel 1312 with the electric field and magnetic field strength pattern of the adjacent unit panel 1312.

If the per-time electric field and magnetic field strength variation of the unit panel 1312 is identical to the pre-stored data, the diagnosis server 1340 displays the state of the unit panel 1312 with an error on the map so that the user may recognize it (S1865).

Although FIG. 18 illustrates that the steps are sequentially performed, this merely provides an embodiment of the disclosure. It would readily be appreciated by a skilled artisan that the steps of FIG. 18 are not limited to the order shown but may rather be performed in a different order, one or more of the steps may simultaneously be performed, or other various modifications or changes may be made thereto without departing from the scope of the disclosure

The steps or processes described above in connection with FIG. 18 may be implemented as computer-readable code in a recording medium. The computer-readable recording medium includes all types of recording devices storing data readable by a computer system. The computer-readable recording medium includes a storage medium, such as a magnetic storage medium (e.g., a ROM, a floppy disk, or a hard disk), an optical reading medium (e.g., a CD-ROM or a DVD), or a carrier wave (e.g., transmission over the Internet). Further, the computer-readable recording medium may be distributed to computer systems connected via a network, and computer-readable codes may be stored and executed in a distributed manner.

The above-described embodiments are merely examples, and it will be appreciated by one of ordinary skill in the art various changes may be made thereto without departing from the scope of the present invention. Accordingly, the embodiments set forth herein are provided for illustrative purposes, but not to limit the scope of the present invention, and should be appreciated that the scope of the present invention is not limited by the embodiments. The scope of the present invention should be construed by the following claims, and all technical spirits within equivalents thereof should be interpreted to belong to the scope of the present invention.

What is claimed is:

1. A solar panel cleaning apparatus moving on a solar panel to remove foreign bodies from the solar panel, comprising:
a brush unit including a first shaft, a first timing pulley formed at each of two opposite ends of the first shaft, and a brush provided around the first shaft;
an apparatus moving unit including a second shaft, a second timing pulley formed at each of two opposite ends of the second shaft, and a roller provided in a preset position of the second shaft, the roller contacting the solar panel;
a connector connecting the first timing pulley with the second timing pulley; and
a motor providing a rotational force to the first shaft of the brush unit, wherein the brush unit may approach or move away from the solar panel.

2. The solar panel cleaning apparatus of claim 1, wherein the brush unit further includes a shaft lift unit to move the first shaft close to or away from the solar panel.

3. The solar panel cleaning apparatus of claim 2, wherein the shaft lift unit includes a thread, and wherein when a coupling member is coupled to the shaft lift unit through the thread, the brush unit approaches or moves away from the solar panel.

4. The solar panel cleaning apparatus of claim 1, wherein the apparatus moving unit receives the rotational force via the connector and receives mechanical power for moving on the solar panel via the roller.

5. The solar panel cleaning apparatus of claim 1, wherein the apparatus moving unit includes a plurality of rollers, each of the plurality of rollers contacting a first end of the solar panel or a second end of the solar panel, the second end opposite to the first end.

6. The solar panel cleaning apparatus of claim 1, wherein the second timing pulley is larger in diameter than the first timing pulley.
